(19) United States
(12) Patent Application Publication
(10) Pub. No.: US 2025/0334896 A1
(43) Pub. Date: Oct. 30, 2025

(54) EXTERNAL ADDITIVE FOR TONER AND TONER

(71) Applicant: CANON KABUSHIKI KAISHA, Tokyo (JP)

(72) Inventors: ICHIRO KANNO, Chiba (JP); MARI KABURAGI, Chiba (JP); HAYATO IDA, Ibaraki (JP)

(21) Appl. No.: 19/187,743

(22) Filed: Apr. 23, 2025

(30) Foreign Application Priority Data
Apr. 25, 2024 (JP) 2024-071466
Mar. 28, 2025 (JP) 2025-056168

(51) Int. Cl. G03G 9/097

(52) U.S. Cl. CPC G03G 9/09775; G03G 9/09708

(57) ABSTRACT

An external additive for toner includes an organosilicon polymer having a siloxane bond. In X-ray photoelectron spectroscopic measurement, when the atomic concentrations of silicon atoms, oxygen atoms, and carbon atoms are dSi, DO, and dC, respectively, and the sum thereof is 100 atom %, the proportion of the atomic concentration of carbon atoms bonding to silicon atoms is 30 to 60 atom %. The silanol group amount measured by titration using KOH is 0.025 to 0.800 mmol/g. When the number of all silicon atoms is 1.00 and the proportions of silicon atoms indicated by Si^{a}, Si^{b}, and Si^{c} in the structural units (a), (b), and (c) below are Pa, Pb, and Pc, respectively, the following expressions (1) and (2) are satisfied:

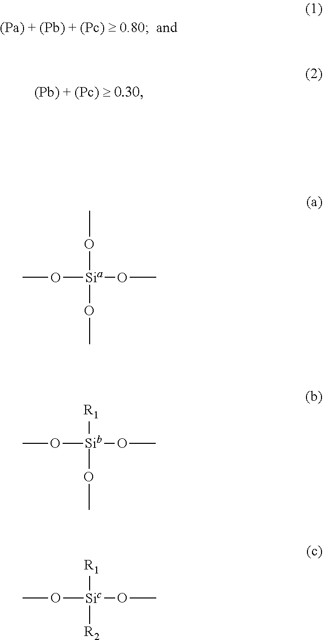

where R₁ and R₂ each independently represent a C1-6 alkyl group.

### BACKGROUND

### Technical Field

The present disclosure relates to an external additive for toner and a toner.

### Description of the Related Art

In recent years, electrophotographic full-color copiers have become widely used and are beginning to be applied to the printing market. In the printing market, along with the increase in speed, there are growing demands for high image quality and high stability.

In order to increase the image quality and stability, the charging characteristics of the toner need to be stabilized. External additives have been variously investigated for stabilizing the charging characteristics of toners.

As an external additive to be used in toners, silica is generally widely known hitherto. Examples of silica with enhanced hydrophobicity by surface treatment of silica generally obtained by dry or wet (sol-gel) method have been reported. For example, Japanese Patent Laid-Open No. 2007-99582 discloses an example of a toner with improved charge stability by adding a highly hydrophobic spherical sol-gel silica microparticle to a toner particle (toner base particle).

Japanese Patent No. 6116711 discloses an example of a toner with improved flowability and charge stability by adding a polyalkyl silsesquioxane microparticle to a toner base particle.

However, the rising speed of initial charging of a toner is low under a high humidity environment, and when images are continuously output, the density variation or color variation of the images may become large.

### SUMMARY

The present disclosure provides an external additive for toner and a toner that solve the above disadvantages. Specifically, charging of a toner is risen rapidly even when an image is output under a high humidity environment, and also an image having charge stability and having suppressed density variation and color variation can be obtained.

The present disclosure provides an external additive for toner comprising an organosilicon polymer having a siloxane bond. In the external additive for toner, in X-ray photoelectron spectroscopic measurement, when the atomic concentration of silicon atoms is dSi, the atomic concentration of oxygen atoms is dO, the atomic concentration of carbon atoms is dC, and the sum thereof is 100 atom %, the proportion of the atomic concentration of carbon atoms bonding to silicon atoms is 30 atom % or more and 60 atom % or less; the silanol group amount measured by titration using KOH is 0.025 mmol/g or more and 0.800 mmol/g or less; and regarding silicon atoms contained in the organosilicon polymer, when the number of all silicon atoms is 1.00, the proportion of silicon atoms indicated by Si^{a} in the structure represented by the unit (a) below is Pa, the proportion of silicon atoms indicated by Si^{b} in the structure represented by the unit (b) below is Pb, and the proportion of silicon atoms indicated by Si^{c} in the structure represented by the unit (c) below is Pc, the Pa, the Pb, and the Pc satisfy the following expressions (1) and (2):

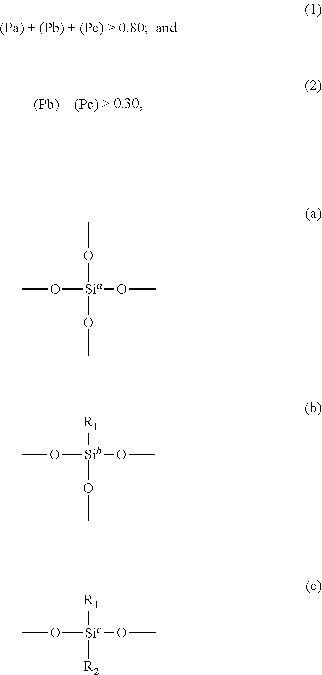

(R₁ and R₂ each independently represent an alkyl group having 1 or more and 6 or less carbon atoms).

The present disclosure relates to a toner including a toner particle and an external additive, and the external additive has the above structure.

Further features of the present disclosure will become apparent from the following description of exemplary embodiments.

### DESCRIPTION OF THE EMBODIMENTS

In the present disclosure, the expression “xx or more and yy or less” or “xx to yy” indicating a numerical range means a numerical range including the lower limit and the upper limit as the endpoints, unless otherwise specified.

The present inventors believe that the mechanism expressing the effects of the present disclosure is as follows.

Silica particles and polyalkyl silsesquioxane particles, which have been used as external additives for toner, are particles of which the main component is a siloxane bond (Si—O—Si). Since the silica particle and the polyalkyl silsesquioxane particle have silanol groups at the ends thereof, unreacted residual silanol groups are present in the particle surface and the inside. Since a silanol group is prone to adsorb water, the charge amount of the toner decreases under a high humidity environment.

Against the above, the chargeability under a high humidity environment has been improved by trimethylsilylation (surface treatment) of the residual silanol group through coupling reaction by a silane compound or the like.

At the same time, it was demonstrated that the charge rising of a toner is highly affected by charging due to ion transfer of hydroxy groups and that the charge rising of the external additive with less silanol groups surface-treated as described above slows down.

The present inventors have conducted extensive research and, as a result, found that the above disadvantages can be solved by optimizing the proportion of the atomic concentration of carbon atoms bonding to silicon atoms in an organosilicon polymer and the silanol group amount, and arrived at the present disclosure.

### External Additive for Toner

The present disclosure provides an external additive for toner, comprising an organosilicon polymer having a siloxane bond. In the external additive for toner, in X-ray photoelectron spectroscopic measurement, when the atomic concentration of silicon atoms is dSi, the atomic concentration of oxygen atoms is dO, the atomic concentration of carbon atoms is dC, and the sum thereof is 100 atom %, the proportion of the atomic concentration of carbon atoms bonding to silicon atoms is 30 atom % or more and 60 atom % or less; the silanol group amount measured by titration using KOH is 0.025 mmol/g or more and 0.800 mmol/g or less; and regarding silicon atoms contained in the organosilicon polymer, when the number of all silicon atoms is 1.00, the proportion of silicon atoms indicated by Si^{a} in the structure represented by the unit (a) below is Pa, the proportion of silicon atoms indicated by Si^{b} in the structure represented by the unit (b) below is Pb, and the proportion of silicon atoms indicated by Si^{c} in the structure represented by the unit (c) below is Pc, the Pa, the Pb, and the Pc satisfy the following expressions (1) and (2):

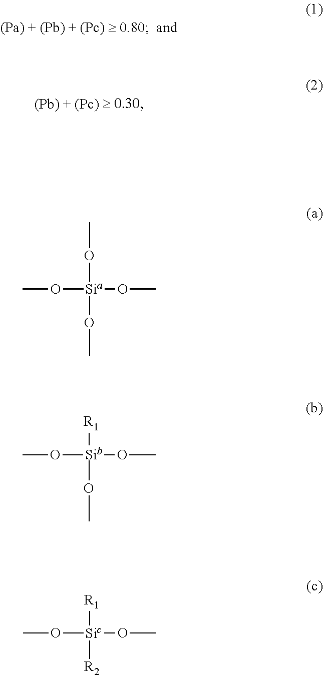

(R₁ and R₂ each independently represent an alkyl group having 1 or more and 6 or less carbon atoms).

Firstly, in the external additive for toner of the present disclosure, in X-ray photoelectron spectroscopic measurement, when the atomic concentration of silicon atoms is dSi, the atomic concentration of oxygen atoms is dO, the atomic concentration of carbon atoms is dC, and the sum thereof is 100 atom %, the proportion of atomic concentration of carbon atoms bonding to silicon atoms is 30 atom % or more and 60 atom % or less.

In the above-mentioned range, the rising of toner charging is improved, and the durable stability is excellent. Accordingly, the concentration stability and color stability of images are improved. When the proportion of atomic concentration of carbon atoms is less than 30 atom %, since the hydrophobicity is insufficient, the charge rising speed under a high humidity environment decreases. When the proportion of atomic concentration of carbon atoms is greater than 60 atom %, since the mechanical strength of the particle decreases, collapse of the external additive occurs, and the charge stability of the toner decreases.

The proportion of the atomic concentration of carbon atoms in the external additive for toner can be controlled by the mixing ratio of an alkoxysilane having the above structure and the type and addition amount of the surface treatment agent. For example, when the proportion of the atomic concentration of carbon atoms is required to decrease, for example, the mixing ratio of the alkoxysilane having the above structure (a) is increased, the mixing ratio of the alkoxysilane having the above structure (b) or (c) is decreased, or the addition amount of the surface treatment agent is decreased. When the proportion of the atomic concentration of carbon atoms is required to increase, for example, the mixing ratio of the alkoxysilane having the above structure (a) is decreased, the mixing ratio of the alkoxysilane having the above structure (b) or (c) is increased, or the addition amount of the surface treatment agent is increased. The proportion of the atomic concentration of carbon atoms in the external additive for toner can be 30 atom % or more and 40 atom % or less.

Secondly, in the external additive for toner of the present disclosure, the silanol group amount measured by titration using KOH is 0.025 mmol/g or more and 0.800 mmol/g or less. When the silanol group amount is within the above range, the charge rising speed of the toner under a high humidity environment can be increased. Accordingly, the initial charge stability can be improved, and the concentration and color variations of images can be suppressed.

The silanol group amount of the external additive for toner can be controlled by the mixing ratio of the alkoxysilane having the above structure, the temperature and time periods of the hydrolysis process and the condensation process, the type and addition amount of the surface treatment agent, and the treatment conditions. For example, when the silanol group amount is required to increase, for example, the mixing ratio of the alkoxysilane having the above structure (a) is increased, the mixing ratio of the alkoxysilane having the above structure (b) or (c) is decreased, the temperature of the hydrolysis and condensation processes is increased, or the time periods of the hydrolysis and condensation processes are increased. When the silanol group amount is required to decrease, for example, the mixing ratio of the alkoxysilane having the above structure (a) is decreased, the mixing ratio of the alkoxysilane having the above structure (b) or (c) is increased, the temperature of the hydrolysis and condensation processes is decreased, or the time periods of the hydrolysis and condensation processes are decreased.

Furthermore, regarding silicon atoms contained in the organosilicon polymer included in the external additive for toner of the present disclosure, when the number of all silicon atoms is 1.00, the proportion of silicon atoms indicated by Si^{a} in the structure represented by the above unit (a) is Pa, the proportion of silicon atoms indicated by Si^{b} in the structure represented by the above unit (b) is Pb, and the proportion of silicon atoms indicated by Si^{c} in the structure represented by the above unit (c) is Pc, the Pa, the Pb, and the Pc satisfy the following expressions (1) and (2):

$$( Pa ) + ( Pb ) + ( Pc ) \geq 0.8 ; and \qquad ( 1 )$$

$$( Pb ) + ( Pc ) \geq 0.3 . \qquad ( 2 )$$

Within the above range, when the toner is subjected to stress from a member such as a carrier, the external additive itself is hardly broken, and, furthermore, the external additive can be prevented from being embedded in the toner particle surface because of its appropriate flexibility. Consequently, the toner surface condition hardly changes, and the chargeability and adhesion of the toner can be more suppressed from changing. The content rates of the above units (a), (b), and (c) in the external additive can be controlled by the addition amount of the alkoxysilane having the above structure.

### Method for Manufacturing External Additive for Toner

The method for manufacturing the external additive for toner of the present disclosure is not particularly limited, but the particles may be formed through hydrolysis and condensation polymerization reactions of a silicon compound (silane monomer) by a sol-gel method. Specifically, a mixture of a difunctional silane having two siloxane bonds and a tetrafunctional silane having four siloxane bonds is hydrolyzed and condensation-polymerized, and colloidal silica or the like is reacted therewith to form a composite particle. Silane monomers such as the difunctional silane and the tetrafunctional silane and the composite particle will be described later. The proportion of the difunctional silane is preferably 30 mol % or more and 70 mol % or less and more preferably 40 mol % or more and 60 mol % or less. The proportion of the tetrafunctional silane is preferably 30 mol % or more and 80 mol % or less and more preferably 40 mol % or more and 70 mol % or less.

The external additive for toner of the present disclosure is a particle containing an organosilicon polymer having a siloxane bond.

The method for manufacturing the organosilicon polymer is not particularly limited, and the organosilicon polymer can be obtained by, for example, dropwise adding a silane compound to water, performing hydrolysis and condensation reactions by a catalyst, and then filtrating and drying the obtained suspension. The particle diameter can be controlled by the type of the catalyst, the mixing ratio, the reaction starting temperature, the time period of dropping, and so on. Examples of the catalyst include, but not limited to, acidic catalysts such as hydrochloric acid, hydrofluoric acid, sulfuric acid, and nitric acid; and basic catalysts such as aqueous ammonia, sodium hydroxide, and potassium hydroxide.

The external additive for toner including the organosilicon polymer can be manufactured by the following method.

Specifically, the method can include a first process of obtaining a hydrolysate of a silicon compound, a second process of mixing the hydrolysate and an alkaline aqueous medium for polycondensation reaction of the hydrolysate, and a third process of mixing the polycondensation reaction product and an aqueous solution for particleization. In some cases, in the third process, a hydrophobizing agent may be further mixed. In the second process, an inorganic microparticle such as colloidal silica or a resin microparticle may be used. Although the details will be described later, these microparticles are the microparticle B in the composite particle.

In the first process, a silicon compound and a catalyst are brought into contact with each other by a method such as stirring or mixing in an aqueous solution prepared by dissolving an acidic or alkaline material that functions as the catalyst in water. As the catalyst, a known catalyst can be suitably used. Specifically, examples of the catalyst include acidic catalysts such as acetic acid, hydrochloric acid, hydrofluoric acid, sulfuric acid, and nitric acid; and basic catalysts such as aqueous ammonia, sodium hydroxide, and potassium hydroxide.

The use amount of the catalyst may be appropriately controlled depending on the types of the silicon compound and catalyst. For example, the use amount can be selected within a range of 1×10⁻³ parts by mass or more and 1 part by mass or less based on 100 parts by mass of water used for hydrolyzing the silicon compound.

When the use amount of the catalyst is 1×10⁻³ parts by mass or more, the reaction proceeds satisfactorily. In contrast, when the use amount of the catalyst is 1 part by mass or less, the amount of the catalyst remaining as an impurity in the microparticle is low, and hydrolysis easily proceeds. The use amount of water can be 2 mol or more and 15 mol or less based on 1 mol of the silicon compound. When the amount of water is 2 mol or more, the hydrolysis reaction proceeds satisfactorily, and when the amount is 15 mol or less, the productivity is improved.

The reaction temperature is not particularly limited, and the reaction may be performed at ordinary temperature or under heating conditions. However, the reaction may be performed while maintaining a temperature of 10° C. to 60° C., because the hydrolysate can be obtained in a short time and also partial condensation reaction of the generated hydrolysate can be suppressed. The reaction time is not particularly limited and may be appropriately selected considering the reactivity of the silicon compound to be used, the composition of a reaction solution prepared from the silicon compound, an acid, and water, and the productivity.

In a method for manufacturing a silicon polymer particle, as the second process, the raw material solution obtained in the first process and an alkaline aqueous medium are mixed to subject the particle precursor to polycondensation reaction. Consequently, a polycondensation reaction solution is obtained. Here, the alkaline aqueous medium is liquid obtained by mixing an alkaline component, water, and an organic solvent or the like as needed.

The alkaline component used in the alkaline aqueous medium is a component whose aqueous solution is basic and functions as a neutralizer for the catalyst used in the first process and functions as a catalyst for the polycondensation reaction in the second process. Examples of the alkaline component include alkali metal hydroxides such as lithium hydroxide, sodium hydroxide, and potassium hydroxide; ammonia; and organic amines such as monomethylamine and dimethylamine.

The use amount of the alkaline component is an amount allowing neutralization of the acid and functioning effectively as a catalyst for the polycondensation reaction. For example, when ammonia is used as the alkaline component, the amount is selected usually within a range of 0.01 parts by mass or more and 12.5 parts by mass or less based on 100 parts by mass of a mixture of water and an organic solvent.

In the second process, in order to prepare an alkaline aqueous medium, in addition to the alkaline component, an organic solvent may be further used. The organic solvent is not particularly limited as long as it has compatibility with water, but an organic solvent that dissolves 10 g or more of water per 100 g under ordinary temperature and normal pressure can be used.

Specifically, examples of the organic solvent include alcohol such as methanol, ethanol, n-propanol, 2-propanol, and butanol; polyhydric alcohol such as ethylene glycol, diethylene glycol, propylene glycol, glycerol, trimethylolpropane, and hexanetriol; ether such as ethylene glycol monoethyl ether, acetone, diethyl ether, tetrahydrofuran, and diacetone alcohol; and amide compounds such as dimethylformamide, dimethylacetamide, and N-methylpyrrolidone.

A mong the above-mentioned organic solvents, an alcoholic solvent such as methanol, ethanol, 2-propanol, and butanol may be used. Furthermore, from the viewpoint of hydrolysis and dehydration condensation reactions, the same alcohol as the alcohol generated by elimination can be selected as the organic solvent.

As the third process, the polycondensation reaction product obtained in the second process is mixed with an aqueous solution for particleization. As the aqueous solution, water (tap water, pure water, or the like) can be suitably used, and water may further contain a component having compatibility with water, such as a salt, an acid, an alkali, an organic solvent, a surfactant, and a water-soluble polymer. The temperature of the polycondensation reaction solution and the aqueous solution when mixed is not particularly limited and may be suitably selected within a range of 5° C. to 70° C. considering the compositions thereof, productivity, and so on.

As the method for collecting the particles, a known method can be used without particular limitation, and examples thereof include a method by scooping floating powder and a filtration method, and the filtration may be used because of its ease of use. The method of filtration is not particularly limited, and a known apparatus for vacuum filtration, centrifugal filtration, pressure filtration, or the like may be selected. The filter paper, filter, filter cloth, and so on that are used for the filtration are not particularly limited as long as it is available industrially and may be appropriately selected depending on the apparatus to be used.

The monomer to be used can be appropriately selected depending on the compatibility with the solvent and catalyst or hydrolyzability. Examples of the tetrafunctional silane monomer having the above structure (a) include tetramethoxysilane, tetraethoxysilane, and tetraisocyanatesilane. Among these monomers, tetraethoxysilane may be used.

Examples of the trifunctional silane monomer having the above structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these monomers, methyltrimethoxysilane may be used.

Examples of the difunctional silane monomer having the above structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. In particular, dimethyldimethoxysilane may be used. Physical properties and forms of external additive for toner

The primary particle of the external additive for toner of the present disclosure can have a number-average diameter of 0.03 μm or more and 0.30 μm or less. When the primary particle has a number-average diameter within the above range, microparticles can be uniformly coated on the toner particles. In addition, since the stress to the toner can be suppressed, the effect of charge stability can be easily obtained. When the primary particle of the microparticle has a number-average diameter of less than 0.03 μm, since the stress to the toner is increased when a large amount of images with low printing density is output over a long period of time, the external additive particle may be easily embedded in the toner surface. When the primary particle has a number-average diameter of greater than 0.30 μm, the external additive particle may be easily eliminated from the toner surface. The number average particle diameter of the primary particle of the external additive can be increased by lowering the reaction temperature, decreasing the reaction time, or increasing the catalyst amount in the hydrolysis and condensation processes. The number average particle diameter of the primary particle of the microparticle can be decreased by raising the reaction temperature, elongating the reaction time, or decreasing the catalyst amount in the hydrolysis and condensation processes.

The number-average diameter of the primary particle of the external additive can be 0.07 μm or more and 0.20 μm or less and further can be 0.08 μm or more and 0.15 μm or less from the viewpoint of the above-described viewpoints.

The external additive for toner of the present disclosure can have a Young's modulus of 10 G Pa or more and 30 GPa or less. When the Young's modulus is within the above range, the stress applied to the toner from a member such as a carrier is relieved, and the external additive can be more suppressed from being embedded into the toner particle surface.

When the Young's modulus is 10 GPa or more, the external additive itself is hardly broken when the toner is subjected to stress from a member such as a carrier. When the Young's modulus is 30 GPa or less, the stress applied to the toner from a member such as a carrier is easily relieved, and the external additive can be more suppressed from being embedded into the toner particle surface. Consequently, the toner surface condition hardly changes, and the chargeability and adhesion of the toner can be more suppressed from changing.

The Young's modulus of the external additive for toner can be controlled by changing the mixing ratio of the alkoxysilane having the above structure and the temperature, time period, pH, and the type of catalyst in the hydrolysis process and the condensation process. For example, when the Young's modulus is required to increase, for example, the mixing ratio of the alkoxysilane having the above structure (a) is increased, the mixing ratio of the alkoxysilane having the above structure (b) or (c) is decreased, the temperature of the hydrolysis and condensation processes is increased, the time periods of the hydrolysis and condensation processes are increased, or the pH values in the hydrolysis and condensation processes are increased.

When the Young's modulus is required to decrease, for example, the mixing ratio of the alkoxysilane having the above structure (a) is decreased, the mixing ratio of the alkoxysilane having the above structure (b) or (c) is increased, the temperature of the hydrolysis and condensation processes is decreased, the time periods of the hydrolysis and condensation processes are decreased, or the pH values in the hydrolysis and condensation processes are decreased. The Young's modulus of the external additive for toner can be 13 GPa or more and 20 GPa or less.

The external additive for toner of the present disclosure is a composite particle including a microparticle A and a microparticle B. The microparticle A is a particle including an organosilicon polymer described already, and the microparticle B can be a microparticle that exists in a state of being at least partially embedded in the surface of the microparticle A functioning as the base particle. Since such a composite particle structure can improve the adhesiveness between the external additive and the toner particle, the charge stability of the toner can be improved over a long period of time, and the density and color variations of images can be further suppressed.

The microparticle B can have a Young's modulus of 50 GPa or more and 200 GPa or less. When the Young's modulus is within the above range, the external additive itself is hardly broken when the toner is subjected to stress from a member such as a carrier, and the durable stability of the toner can be improved.

The microparticle B exists in a state of being at least partially embedded in the surface of the microparticle A, and the average embedded rate may be 30% or more and 90% or less. When the average embedded rate is within the above range, elimination of the microparticle B hardly occurs when the toner is subjected to stress from a member such as a carrier, and contamination of the carrier and the charge member can be suppressed. The embedded rate of the microparticle B can be controlled by the time and temperature of the reaction with the alkoxysilane having the above structure. When the embedded rate is required to decrease, for example, the time of the reaction between the alkoxysilane and the microparticle B is decreased or the reaction temperature is decreased. When the embedded rate is required to increase, for example, the time of the reaction between the alkoxysilane and the microparticle B is increased or the reaction temperature is increased.

As the microparticle B, an inorganic microparticle or a resin microparticle can be used, and a silica microparticle such as colloidal silica can be used in terms of suppression of elimination from the microparticle A being an organosilicon polymer particle.

When the external additive for toner of the present disclosure is washed by the washing method below, in X-ray photoelectron spectroscopic measurement, when the atomic concentration of silicon atoms is dSi, the atomic concentration of oxygen atoms is dO, the atomic concentration of carbon atoms is dC, and the sum thereof is 100 atom %, the proportion of atomic concentration of carbon atoms bonding to silicon atoms is 30 atom % or more, and the silanol group amount in the external additive for toner measured by titration using KOH can be 0.025 mmol/g or more and 0.800 mmol/g or less.

### Washing Method

a) 10 g of the external additive for toner is dispersed in 200 ml of hexane, followed by ultrasonication (frequency: 30 kHz, output capacity: 15 W, intensity: 100%, time: 5 minutes); and
b) hexane is distilled off from the dispersion of the external additive for toner.

Within the above range, the charge stability of the toner can be improved over a long period of time, and the density and color variations of images can be further suppressed. The silanol group amount of the external additive for toner can be controlled by the mixing ratio of the alkoxysilane having the above structure, the temperature and time periods of the hydrolysis process and the condensation process, the type and addition amount of the surface treatment agent, and the treatment conditions. For example, when the silanol group amount is required to increase, for example, the mixing ratio of the alkoxysilane having the above structure (a) is increased, the mixing ratio of the alkoxysilane having the above structure (b) or (c) is decreased, the temperature of the hydrolysis and condensation processes is increased, or the time periods of the hydrolysis and condensation processes are increased. When the silanol group amount is required to decrease, for example, the mixing ratio of the alkoxysilane having the above structure (a) is decreased, the mixing ratio of the alkoxysilane having the above structure (b) or (c) is increased, the temperature of the hydrolysis and condensation processes is decreased, or the time periods of the hydrolysis and condensation processes are decreased.

The content of the external additive for toner of the present disclosure can be 0.1 parts by mass or more and 20.0 parts by mass or less based on 100 parts by mass of the toner particle from the viewpoint of charge stability and is more preferably 0.5 parts by mass or more and 15.0 parts by mass or less and further preferably 1.0 parts by mass or more and 10.0 parts by mass or less.

When the content of the external additive is less than 0.1 parts by mass, since the stress to the toner cannot be suppressed when a large amount of images with low printing density is output over a long period of time under an extreme environment such as a high-temperature and high-humidity environment, and the effect of durable stability is hardly obtained. When the content of the external additive is greater than 20.0 parts by mass, there is a risk of occurrence of filming of the external additive particles on the carrier, the charge member, and the photosensitive member.

### Toner Particle

Subsequently, the structure of the toner particle to which the external additive for toner of the present disclosure is externally added will be described in detail.

### Binder Resin

The binder resin contained in the toner particle is not particularly limited, and the following polymer or resin can be used.

For example, it is possible to use a homopolymer of styrene or its substitute, such as polystyrene, poly-p-chlorostyrene, or polyvinyltoluene; a styrenic copolymer such as a styrene-p-chlorostyrene copolymer, a styrene-vinyltoluene copolymer, a styrene-vinylnaphthalene copolymer, a styrene acrylic acid ester copolymer, a styrene-methacrylic acid ester copolymer, a styrene-a-methyl chloromethacrylate copolymer, a styrene-acrylonitrile copolymer, a styrene-vinylmethyl ether copolymer, a styrene-vinylethyl ether copolymer, a styrene-vinylmethyl ketone copolymer, or a styrene-acrylonitrile-indene copolymer; or a polyvinyl chloride, a phenolic resin, a naturally modified phenolic resin, a natural resin modified maleic acid resin, an acrylic resin, a methacrylic resin, a polyvinyl acetate, a silicone resin, a polyester resin, a polyurethane, a polyamide resin, a furan resin, an epoxy resin, a xylene resin, a polyvinyl butyral, a terpene resin, a coumarone-indene resin, or a petroleum resin. In particular, from the viewpoint of durable stability and charge stability, a polyester resin can be used.

The polyester resin can have an acid value of 0.5 mg KOH/g or more and 40 mg KOH/g or less from the viewpoint of environmental stability and charge stability. The acid value in the polyester resin and the Si-CH3 in the microparticle interact to more improve the durability and the toner chargeability under a high-temperature and high-humidity environment. The acid value is more preferably 1 mg KOH/g or more and 20 mg KOH/g or less and further preferably 1 mg KOH/g or more and 15 mg KOH/g or less.

### Coloring Agent

The toner particle may contain a coloring agent. Examples of the coloring agent include the following.

Examples of black coloring agents include carbon black; and a coloring agent toned to black using a yellow coloring agent, a magenta coloring agent, and a cyan coloring agent. As the coloring agent, a pigment may be used alone, but the clarity may be improved by using a dye and a pigment in combination in terms of the quality of full-color images.

Examples of pigments for magenta toner include the following: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of dyes for magenta toner include the following: oil dyes such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1, and basic dyes such as C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

Examples of pigments for cyan toner include the following: C.I. Pigment Blue 2, 3, 15:2, 15:3, 15:4, 16, and 17; C.I. Vat Blue 6; C.I. Acid Blue 45; and copper phthalocyanine pigment having 1 to 5 phthalimidomethyl groups substituted on the phthalocyanine skeleton.

Examples of dyes for cyan toner include C.I. Solvent Blue 70.

Examples of pigments for yellow toner include the following: C.I. Pigment Y ellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Y ellow 1, 3, and 20. Examples of dyes for yellow toner include C.I. Solvent Y ellow 162.

The content of the coloring agent can be 0.1 parts by mass or more and 30.0 parts by mass or less based on 100 parts by mass of the binder resin.

### Wax

The toner particle may contain a wax. Examples of the wax are as follows:

Hydrocarbon waxes such as a microcrystalline wax, a paraffin wax, and a Fischer-Tropsch wax; oxides of hydrocarbon waxes, such as polyethylene oxide wax, and block copolymers thereof; waxes of which the main components are fatty acid esters, such as a carnauba wax; and partially or totally deacidified fatty acid esters, such as a deacidified carnauba wax.

Furthermore, examples of the wax include the following: saturated linear fatty acids such as palmitic acid, stearic acid, and montanoic acid; unsaturated fatty acids such as brassic acid, eleostearic acid, and parinaric acid; saturated alcohols such as stearyl alcohol, aralkyl alcohol, behenyl alcohol, carnaubil alcohol, ceryl alcohol, and melissyl alcohol; polyhydric alcohols such as sorbitol; esters of fatty acids, such as palmitic acid, stearic acid, behenic acid, and montanoic acid, and alcohols, such as stearyl alcohol, aralkyl alcohol, behenyl alcohol, carnaubil alcohol, ceryl alcohol, and melissyl alcohol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylenebisstearic acid amide and N,N′-distearylisophthalic acid amide; aliphatic metal salts (those generally called metal soap) such as calcium stearate, calcium laurate, zinc stearate, and magnesium stearate; aliphatic hydrocarbon waxes grafted by a vinyl monomer such as styrene or acrylic acid; partially esterified products of fatty acid such as behenic acid monoglyceride and polyhydric alcohol; and methyl ester compounds having hydroxyl groups obtained by hydrogenation of vegetable oils.

The content of the wax may be 2.0 parts by mass or more and 30.0 parts by mass or less based on 100 parts by mass of the binder resin.

### Charge Controlling Agent

The toner particle may contain a charge controlling agent. As the charge controlling agent to be contained in the toner, a known agent can be used, but a metal compound of an aromatic carboxylic acid can be used because it is colorless and can charge toner quickly and stably maintain a certain charge amount.

Examples of the negative charge controlling agent include a metal salicylate compound, a metal naphthoate compound, a metal dicarboxylate compound, a polymeric compound having sulfonic acid or carboxylic acid in the side chain, a polymeric compound having a sulfonate or esterified sulfonic acid in the side chain, a polymeric compound having a carboxylate or esterified carboxylic acid in the side chain, a boron compound, a urea compound, a silicon compound, and a calixarene. The charge controlling agent may be internally added or externally added to the toner particle.

The addition amount of the charge controlling agent may be 0.2 parts by mass or more and 10.0 parts by mass or less based on 100 parts by mass of the binder resin. Inorganic fine powder

The toner of the present disclosure can use, in addition to the above-described external additive for toner, another inorganic fine powder as needed. The inorganic fine powder may be internally added to the toner particle or may be mixed with the toner particle as an external additive. The external additive can be inorganic fine powder such as silica.

The inorganic fine powder can be hydrophobized with an agent such as a silane compound, silicone oil, or a mixture thereof.

The external additive for improving the flowability or durability can be inorganic fine powder having a specific surface area of 50 m²/g or more and 400 m²/g or less. The inorganic fine powder can be used in an amount of 0.1 parts by mass or more and 10.0 parts by mass or less based on 100 parts by mass of the toner particle. When the above-mentioned range is satisfied, a durable stability effect is easily obtained.

### Developing Agent

The toner of the present disclosure can be used as a one-component system developing agent, but may be mixed with a magnetic carrier and used as a two-component system developing agent in terms of improving the dot reproducibility and obtaining stable images over a long period of time.

As the magnetic carrier, generally known carriers, for example, iron powder with oxidized or unoxidized surface, metal particles such as iron, lithium, calcium, magnesium, nickel, copper, zinc, cobalt, manganese, chromium, and rare earth elements, particles of alloys thereof, oxide particles, magnetic materials such as ferrite, and a magnetic material dispersion resin carrier containing a magnetic material and a binder resin maintaining the magnetic material in a dispersion state (i.e., resin carrier), can be used.

When the toner is mixed with a magnetic carrier and used as a two-component system developing agent, the carrier mixing ratio at that time can be 2 mass % or more and 15 mass % or less as the toner concentration in the two-component system developing agent and may be 4 mass % or more and 13 mass % or less, which generally gives good results.

### Method for Generating Toner Particle and Method for Manufacturing Toner

The method for manufacturing the toner particle is not particularly limited, and a known manufacturing method, such as a suspension polymerization method, an emulsion aggregation method, a melt kneading method, and a dissolution suspension method, can be adopted.

The obtained toner particle may be mixed with the external additive for toner of the present disclosure and another external additive as needed to obtain a toner. The mixing of the toner particle, the external additive for toner of the present disclosure, and another external additive can use a mixing apparatus such as a double cone mixer, a V-type mixer, a drum mixer, a super mixer, a Henschel mixer, a Nauta mixer, Mechano-Hybrid (manufactured by Nippon Coke & Engineering Co., Ltd.), and Nobilta (manufacturing by Hosokawa Micron Corporation).

### Method for Measuring Various Physical Properties

Methods for measuring various physical properties will be described below.

### Separation of External Additive and Toner Particle

Various physical properties can also be measured using external additive separated from a toner by the following method.

Sucrose (200 g, manufactured by Kishida Chemical Co., Ltd.) was added to deionized water (100 mL) and was dissolved while warming in a hot water bath to prepare a sucrose thick liquid. The sucrose thick liquid (31 g) and Contaminon N (6 mL, a 10 mass % aqueous solution of a neutral detergent for cleaning precision measuring instruments, composed of a nonionic surfactant, an anionic surfactant, and an organic builder and having a pH of 7, manufactured by FUJIFILM Wako Pure Chemical Corporation) were put in a centrifuge tube to produce a dispersion. The toner (1 g) was added to this dispersion, and clumps of the toner are loosened with a spatula or the like.

The centrifuge tube is shaken with the above-mentioned shaker at 350 strokes per minute for 20 minutes. After the shaking, the solution is transferred to a swing rotor glass tube (50 mL) and is centrifuged with a centrifuge at 3500 rpm for 30 minutes. In the glass tube after the centrifugation, the toner is present in the uppermost layer, and the microparticles are present in the aqueous solution as the bottom layer. The aqueous solution as the bottom layer is collected and centrifugated to separate sucrose and microparticles, and the microparticles are collected. As needed, centrifugation is repeated to sufficiently perform separation, and the dispersion is dried, and the microparticles are collected.

When multiple external additives are added, the external additive according to the present disclosure can be separated by utilizing centrifugation or the like. Method for measuring carbon concentration, oxygen concentration, and silicon concentration of external additive by electron spectroscopy for chemical analysis (ESCA)

The method for measuring the carbon concentration, oxygen concentration, silicon concentration on the surface of the external additive by ESCA will be shown below.

The apparatus and measurement conditions of ESCA are as follows:
Apparatus: Quantum 2000 (manufactured by Ulvac-Phi, Incorporated);
X-ray source: monochromatized Al-Kα;
Sample measurement range: diameter of 100 μm;
Photoelectron uptake angle: 45°;
X-ray: 50 μm, 12.5 W, 15 kV;
Raster: 300 μm×200 μm;
PassEnergy: 46.95 eV;
Step Size: 0.200 eV;
Neutralization electron gun: 20 μA, 1 V;
Arion gun: 7 mA, 10 V; and
No. of sweep: C: 20 times, 0:10 times, and Si: 15 times.

The measurement principle is as follows: Photoelectrons are generated using an X-ray source, and the energy based on the inherent chemical bonds of a material is measured. The surface atom concentration (atom %) is calculated from the peak intensity of each of the measured elements using a relative sensitivity factor provided by PHI.

The proportion of carbon atoms is calculated as the rate of carbon atoms to the sum of the carbon concentration, oxygen concentration, and silicon concentration [dC/(dC+dO+dSi)]×100).

### Method for Measuring Silanol Group Amount of External Additive Measured by Titration Using KOH

The silanol group amount of the external additive is measured by a modified method of a method of quantitatively measuring silanol groups by titration based on the Sears method.

### Preparation of Measurement Solution

An external additive (2.0 g) and ethanol (25 g) are put in a 200-ml beaker, and the beaker is shaken by hand to wet the external additive with ethanol. A 20% NaCl aqueous solution (75 g) is added thereto, followed by dispersion by ultrasonic dispersion for 1 minute.

### Measurement

The external additive dispersion in the beaker is stirred with a stirrer. A 0.1 mol/L HCl aqueous solution is dropwise added thereto with a micropipette to adjust the pH to 4.0. A 0.1 mol/L KOH solution is dropwise added as the titration solution, and the amount of the 0.1 mol/L KOH dropwise added until the pH becomes 9.0 is defined as the silanol group amount (mmol/g). Specifically, the silanol group amount per unit mass of microparticle is calculated by the following expression:

$$Silanol group amount ( mmol / g ) = dropped KOH amount ( mmol ) / 2. ( g ) ( microparticle amount in the sample ) .$$

### Method for Measuring Number Average Particle Diameter of Primary Particle of External Additive

The number average particle diameter of primary particle of the external additive can be determined through measurement by centrifugal precipitation. Specifically, dried external additive particle (0.01 g) is charged in a 25-mL glass vial, and a 5% triton solution (0.2 g) and reverse osmosis (RO) water (19.8 g) are added thereto to produce a solution. Subsequently, the probe (the very tip of the tip) of an ultrasonic disperser is immersed in the above solution, and ultrasonic dispersion is performed at an output of 20 W for 15 minutes to obtain a dispersion. Subsequently, using this dispersion, the number average particle diameter of the primary particle is measured with a centrifugal precipitation particle size analysis system DC 24000 (CPS Instruments). The rotation speed of the disk is set to 18,000 rpm, and the true density is set to 1.3 g/cm³. Before the measurement, the apparatus is calibrated using a polyvinyl chloride particle with an average particle diameter of 0.476 μm.

### Method for Measuring Young's Modulus of External Additive

The Young's modulus of the external additive is determined by a microcompression test using Hysitron PI 85L Picolndenter (manufactured by BRUKER). The measurement conditions are as shown below, and the Young's modulus (MPa) is calculated from the displacement (nm) obtained by measurement and the slope of a profile (load-displacement curve) of a load (UN).

### Equipment and Jig

Base system: Hysitron PI-85L;
Measurement indenter: circular flat end indenter with a diameter of 1 μm;
Used SEM: Thermo Fisher Versa 3D; and
SEM conditions: −10° tilt, 13 pA at 10 keV.

### Measurement Conditions

Measurement mode: displacement control;
Maximum displacement: 30 nm;
Displacement rate: 1 nm/sec;
Retention time: 2 seconds; and
Unloading rate: 5 nm/sec.

### Analysis Method

The Young's modulus of the microparticle is calculated by adapting Hert's analysis to the obtained load-displacement curve when compressed from 0 nm to 10 nm.

### Sample

The external additive is adhered on a silicon wafer and used.

### Method for Measuring Young's Modulus of Microparticle B

The composition of the microparticle B is firstly identified. The measurement is performed using a scanning electron microscope “S-4800” (trade name, manufactured by Hitachi, Ltd.). The external additive for toner of the present disclosure causes a difference in image contrast between a portion derived from the inorganic microparticle B and a portion derived from the organic microparticle A and is distinguished from an external additive other than the external additive for toner of the present disclosure in which no difference occurs in the contrast. In addition, the inorganic microparticle B is observed to have higher brightness. The compositions of the microparticle A and the microparticle B are identified by observing external additives with an energy dispersive X-ray analyzer in a field of view magnified up to a magnification of 2 million times. The composition of the microparticle B is identified, and a microparticle with the same composition as that of the microparticle B is then prepared and is subjected to the same measurement as the above-described measurement of the Young's modulus of an external additive to determine the Young's modulus of the microparticle B. Method for measuring embedded rate of microparticle B

An external additive is sufficiently dispersed in a visible light curing resin (trade name, A RONIX LCR series D-800, manufactured by Toagosei Co., Ltd.) and is then cured by irradiation with short wavelength light. The obtained cured product is cut out with an ultramicrotome provided with a diamond knife to produce a 250 nm thin sample. Subsequently, the cut out sample is amplified to 40,000 to 50,000 times using a transmission electron microscope (electron microscope JEM-2800 (TEM-EDX), manufactured by JEOL Ltd.), and the external additive cross section is then observed. The diameter of the microparticle B and the depth of the microparticle B embedded in the microparticle A are measured from the cross section image. Five particles of the microparticle B is randomly selected for one particle of the external additive, and the embedded rate of the microparticle B is calculated by the expression below. The number of particles for analysis is 20 or more external additive particles, and the average thereof is defined as the embedded rate of the microparticle B.

$$Embedded rate ( \% ) of microparticle B = [ ( depth of microparticle B embedded in microparticle A ) / ( diameter of microparticle B ) ] \times 100$$

### Method for Measuring Content Rate of Constituent Component of Organosilicon Polymer by Solid ²⁹Si-NMR

In solid ²⁹Si-NMR, depending on the structure of the functional group bonding to Si in the constituent component of the organosilicon polymer, a peak is detected in a different shift region. The structure bonding to Si can be specified by specifying each peak position using a standard sample. The content ratio of each constituent component can be calculated from the obtained peak area. The rates of peak areas of M unit structure, D unit structure (c), T unit structure (b), and Q unit structure (a) to the total peak area can be determined by calculation. When the external additive has an inorganic silicon compound such as silica particles on the surface, the inorganic silicon compound can be removed by centrifuging in the strongly alkaline solution (pH 12 to 14). The measurement conditions of solid ²⁹Si-NMR are specifically as follows.
Apparatus: J NM-ECX 5002 (JEOL RESONANCE Co., Ltd.);
Temperature: room temperature;
Measurement method: DDMAS method, ²⁹Si, 45°;
Specimen tube: zirconia, 3.2 mm diameter;
Specimen: filled in a test tube in a powder state;
Specimen rotation speed: 10 kHz;
Relaxation delay: 180 s; and
Scan: 2000.

After the measurement, multiple silane components with different substituents and bonding groups in the specimen are peak-separated by curve fitting into M unit structure, D unit structure, T unit structure, and Q unit structure to calculate the respective peak areas.

The curve fitting is performed using EX calibur for Windows (registered trademark) version 4.2 (EX series), which is software for J NM-EX 400 manufactured by JEOL Ltd. “1D Pro” in the menu icons is clicked to load the measurement data. Subsequently, “Curve fitting function” is selected from the “Command” in the menu bar to perform curve fitting. The curve fitting for each component is performed such that the difference between the synthetic peak of each peak obtained by the curve fitting and the peak of the measurement result (synthetic peak difference) is minimum.
Structure (1): M unit structure;
Structure (2): D unit structure;
Structure (3): T unit structure; and
Structure (4): Q unit structure.

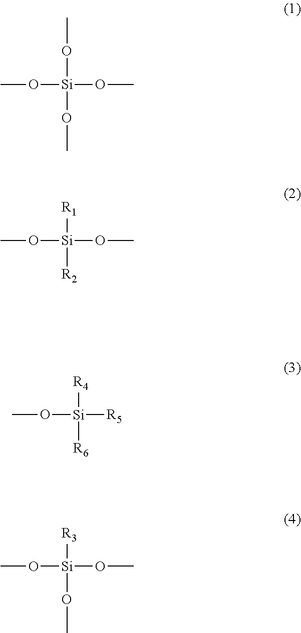

R₁ to R₆ in the above expressions indicate an organic group, such as a hydrocarbon group having 1 to 6 carbon atoms (e.g., an alkyl group), and a halogen atom. The content rates of each of the structures in the inorganic silicon component are calculated from the peak area corresponding to the structure represented by the structures (1) to (4). When further details of the structure are required, identification may be performed by the measurement results of ¹³C-NMR and ¹H-NMR together with the measurement results of ²⁹Si-NMR.

### Method for Measuring Surface Treatment Agent of External Additive

The surface treatment agent of the external additive is analyzed by thermal decomposition GC-MS (gas chromatography-mass spectrometry).

Specific measurement conditions are as follows:
Apparatus: GC 6890A (manufacture by A gilent), pyrolyzer (manufactured by Japan Analytical Industry Co., Ltd.);
Column: HP-5 ms, 30 m; and
Thermal decomposition temperature: 590° C.

The surface treatment agent of the external additive is specified by specifying each peak position of the profile obtained by measurement using a standard sample.

### Method for Measuring Acid Value of Binder Resin

The acid value is the number of milligrams of potassium hydroxide required to neutralize acid components such as free fatty acids and resin acids contained in 1 g of a specimen. The acid value is measured in accordance with JIS-K 0070-1992 as follows.

### (1) Reagent

Phenolphthalein (1.0 g) is dissolved in ethyl alcohol (90 mL, 95 vol %), and deionized water is added thereto to make 100 mL to obtain a phenolphthalein solution.

Special grade potassium hydroxide (7 g) is dissolved in water (5 mL), and ethyl alcohol (95 vol %) is added thereto to make 1 L. The resulting solution is put in an alkali resistant container while avoiding contact with carbon dioxide and so on and is left to stand for 3 days and is then filtered to obtain a potassium hydroxide solution. The obtained potassium hydroxide solution is stored in an alkali resistant container. Regarding a factor of the potassium hydroxide solution, a 0.1 mol/L hydrochloric acid (25 mL) is put in a conical flask, several drops of the phenolphthalein solution is added to the flask, titration is performed with the potassium hydroxide solution, and the factor is determined from the amount of the potassium hydroxide solution required for neutralization. The 0.1 mol/L hydrochloric acid is produced in accordance with JIS K 8001-1998.

### (2) Operation

### (A) Main Examination

A specimen of a pulverized binder resin (2.0 g) is precisely weighted in a 200-ml conical flask, 100 ml of a solution mixture of toluene and ethanol (2:1) is added thereto, and the specimen is dissolved in the solution mixture over 5 hours. Subsequently, several drops of the phenolphthalein solution is added thereto as an indicator, and titration is performed using the potassium hydroxide solution. The titration endpoint is when the indicator remains a pale red color for approximately 30 seconds.

### (B) Blank Examination

The same titration is performed as in the above operation except that the specimen is not used (i.e., the solution mixture of toluene and ethanol (2:1) only is used).

### (3) The Acid Value is Calculated by Substituting the Obtained Result for the Following Expression:

$$A = [ ( C - B ) \times f \times 5.61 ] / S .$$

Here, A: acid value (mg KOH/g), B: addition amount (mL) of potassium hydroxide solution in blank examination, C: addition amount (mL) of potassium hydroxide solution in main examination, f: factor of potassium hydroxide solution, and S: mass (g) of specimen.

### Measurement of Acid Value of Polyester Resin From Toner

The acid value of the polyester resin from a toner can be measured by the following method. The acid value of the polyester resin separated from a toner by the following method is measured.

A toner is dissolved in tetrahydrofuran (THF), and the solvent is removed from the obtained soluble fraction by distillation under reduced pressure to obtain a tetrahydrofuran (THF)-soluble component in the toner.

The obtained tetrahydrofuran (THF)-soluble component of the toner is dissolved in chloroform to prepare a specimen solution in a concentration of 25 mg/mL.

The obtained specimen solution (3.5 mL) is injected in the apparatus below to separate the component with a molecular weight of 2,000 or more as a resin component under the following conditions:
Preparative GPC apparatus: manufactured by Japan Analytical Industry Co., Ltd.,
Preparative HPLC LC-980 model;
Preparative column: JAIGEL 3H, JAIGEL 5H (manufactured by Japan Analytical Industry Co., Ltd.);
Eluate: chloroform; and
Flow rate: 3.5 mL/min.

A high molecular weight component derived from the resin is separated, the solvent is then distilled under reduced pressure, and drying in an atmosphere of 90° C. under reduced pressure for 24 hours. This procedure is repeated until about 2.0 g of the resin component is obtained.

The acid value is measured using the obtained specimen according to the following procedure.

### Method for Measuring Weight-Average Particle Diameter (D4) of Toner

The weight-average particle diameter (D4) of a toner is calculated as follows. As the measurement apparatus, a particle counter analyzer “CDA-1000X” (manufactured by Sysmex Corporation) provided with an aperture tube of 100 μm and adopting an aperture impedance method is used. Setting of measurement conditions and analysis of measurement data use the included dedicated software “CDA-1000X (manufactured by Sysmex Corporation).

As the electrolyte aqueous solution to be used for the measurement, for example, “Cellpack” (manufactured by Sysmex Corporation) can be used.

Before performing the measurement and analysis, the dedicated software is set as follows.

On the “Measurement Condition Setting” screen of the dedicated software, the total counting number is set to 50,000, the number of repeating measurements is set to once, and the measurement mode is set to total counting number (no limitation).

Specific measurement method is as follows.

(1) An electrolyte aqueous solution (about 150 mL) is placed in a dedicated round-bottomed glass beaker, the beaker is set on a sample stage, and stirring with a stirring propeller is performed at 500 rpm. The “Blank Check Measurement” in the dedicated software is then clicked to start the measurement, and it is verified that the count is less than 500. When the count is 500 or more, washing of the beaker and the aperture is repeated.

(2) The electrolyte aqueous solution (about 30 mL) is placed in a 100-ml flat-bottomed glass beaker. A dilute solution (about 0.3 mL) of a dispersant “Contaminon N” (a 10 mass % aqueous solution of a neutral detergent for cleaning precision measuring instruments, composed of a nonionic surfactant, an anionic surfactant, and an organic builder and having a pH of 7, manufactured by FUJIFILM Wako Pure Chemical Corporation) diluted with deionized water by about 3 mass times is added to the beaker.

(3) An ultrasonic disperser, “Ultrasonic Dispersion System Tetra150” (manufactured by Nikkaki Bios Co., Ltd.), that incorporates two oscillators with a frequency of 50 kHz, with a phase shift of 180 degrees, and has an electrical output of 120 W is provided. About 3.3 L of deionized water is placed in the water tank of the ultrasonic disperser, and about 2 mL of Contaminon N is added to this water tank.

(4) The beaker of the above (2) is set in a beaker fixing hole of the ultrasonic disperser, and the ultrasonic disperser is operated. The height position of the beaker is adjusted such that the resonance state of the liquid surface of the electrolyte aqueous solution in the beaker becomes maximum.

(5) A bout 10 mg of a toner is gradually added to and dispersed in the electrolyte aqueous solution in the beaker of the above (4) under irradiation with ultrasonic waves. Ultrasonic dispersion is continued for further 60 seconds.

In the ultrasonic dispersion, the water temperature in the water tank is appropriately adjusted to 10° C. or more and 40° C. or less.

(6) The electrolyte aqueous solution of the above (5), in which the toner is dispersed, is dropwise added to the round-bottomed beaker of the above (1) set in the sample stand using a pipette to adjust the measurement concentration to about 6%. The measurement is then performed until the number of measured particles reaches 50,000.

(7) The measurement data are analyzed by the dedicated software attached to the apparatus, and the weight-average particle diameter (D4) is calculated.

### EXAMPLES

The present disclosure will be more specifically described by Examples shown below. However, these Examples do not limit the present disclosure in any way. Unless otherwise specified, “parts” in the following formulations are all based on mass.

### Manufacturing Example of External Additive 1 for Toner

### 1. Hydrolysis and Condensation Polymerization Process

(1) RO water (21.6 g), methanol (135.0 g), a catalyst acetic acid (0.004 g), and dimethyldimethoxysilane (12.2 g) were charged in a 500-ml beaker and were stirred at 45° C. for 5 minutes.

(2) A 28% aqueous ammonia (2.0 g), tetraethoxysilane (15.0 g), and colloidal silica aqueous dispersion A (silica solid content: 40 mass %, particle diameter: 40 nm, 5.0 g) were added to the above solution, followed by stirring at 30° C. for 3.0 hours to obtain a raw material solution.

### 2. Particleization Process

RO water (120.0 g) was charged in a 1000-ml beaker, and the raw material solution obtained in the process of the above 1 was dropwise added thereto over 5 minutes while stirring at 25° C. Subsequently, this mixture solution was heated to 60° C. and stirred for 1.5 hours while maintaining the temperature of 60° C. to obtain a dispersion of an external additive microparticle.

### 3. Surface Treatment Process

Tetraethoxysilane (3.0 g) and dimethyldimethoxysilane (3.0 g) were added to the dispersion of the external additive microparticle obtained in the above 2. Particleization process, followed by stirring at 60° C. for 3.0 hours. After leaving to stand for 5 minutes, the powder precipitated at the bottom of the solution was collected by suction filtration and dried at 120° C. for 24 hours under reduced pressure to obtain an external additive 1 for toner. The number average particle diameter of the primary particle diameter of the external additive 1 for toner was 0.12 um.

### Manufacturing Example of External Additive 2 for Toner

An external additive 2 for toner was obtained as in the “Manufacturing example of external additive 1 for toner” except that in the above 3. Surface treatment process, the stirring temperature was changed to 45° C. and the stirring time was changed to 1.0 hours.

### Manufacturing Example of External Additive 3 for Toner

### 1. Hydrolysis and Condensation Polymerization Process

(1) RO water (21.6 g), methanol (135.0 g), a catalyst acetic acid (0.004 g), and dimethyldimethoxysilane (12.2 g) were charged in a 500-ml beaker and were stirred at 45° C. for 5 minutes.

(2) A 28% aqueous ammonia (2.0 g) and tetraethoxysilane (15.0 g) were added to the above solution, followed by stirring at 30° C. for 2.0 hours.

(3) Colloidal silica aqueous dispersion A (silica solid content: 40 mass %, particle diameter: 40 nm, 5.0 g) was further added to the above, followed by stirring for 10 minutes to obtain a raw material solution.

### 2. Particleization Process

RO water (120.0 g) was charged in a 1000-ml beaker, and the raw material solution obtained in the process of the above 1 was dropwise added thereto while stirring at 25° C. over 5 minutes. Subsequently, this mixture solution was heated to 60° C., followed by stirring for 1.5 hours while maintaining the temperature of 60° C. to obtain a dispersion of an external additive microparticle.

### 3. Surface Treatment Process

Tetraethoxysilane (3.0 g) and dimethyldimethoxysilane (3.0 g) were added to the dispersion of the external additive microparticle obtained in the above 2. Particleization process, followed by stirring at 60° C. for 3.0 hours. After leaving to stand for 5 minutes, the powder precipitated at the bottom of the solution was collected by suction filtration and dried at 120° C. for 24 hours under reduced pressure to obtain an external additive 3 for toner.

### Manufacturing Example of External Additive 4 for Toner

An external additive 4 for toner was obtained as in the “Manufacturing example of external additive 1 for toner” except that in the above (2) of 1. Hydrolysis and condensation polymerization process, the stirring temperature was changed to 45° C.

### Manufacturing Example of External Additive 5 for Toner

An external additive 5 for toner was obtained as in the “Manufacturing example of external additive 1 for toner” except that in the above (2) of 1. Hydrolysis and condensation polymerization process, a polyester resin microparticle dispersion (solid content: 25 mass %, particle diameter: 50 nm) was used instead of the colloidal silica aqueous dispersion A.

### Manufacturing Example of External Additive 6 for Toner

An external additive 6 for toner was obtained as in the “Manufacturing example of external additive 1 for toner” except that in the above (2) of 1. Hydrolysis and condensation polymerization process, no colloidal silica aqueous dispersion A was added.

### Manufacturing Example of External Additive 7 for Toner

An external additive 7 for toner was obtained as in the “Manufacturing example of external additive 1 for toner” except that in the above (1) of 1. Hydrolysis and condensation polymerization process, the amount of dimethyldimethoxysilane was changed to 12.7 g and that in the above (2), the amount of tetraethoxysilane was changed to 14.5 g.

### Manufacturing Example of External Additive 8 for Toner

An external additive 8 for toner was obtained as in the “Manufacturing example of external additive 1 for toner” except that in the above (1) of 1. Hydrolysis and condensation polymerization process, the amount of dimethyldimethoxysilane was changed to 7.2 g and that in the above (2), the amount of tetraethoxysilane was changed to 20.0 g.

### Manufacturing Example of External Additive 9 for Toner

An external additive 9 for toner was obtained as in the “Manufacturing example of external additive 1 for toner” except that in the above (1) of 1. Hydrolysis and condensation polymerization process, the amount of dimethyldimethoxysilane was changed to 7.2 g and that in the above (2), no tetraethoxysilane was added and 20.0 g of trimethoxymethylsilane was added.

### Manufacturing Example of External Additive 10 for Toner

An external additive 10 for toner was obtained as in the “Manufacturing example of external additive 1 for toner” except that in the above (1) of 1. Hydrolysis and condensation polymerization process, the amount of dimethyldimethoxysilane was changed to 3.2 g and that in the above (2), the mount of tetraethoxysilane was changed to 24.0 g.

### Manufacturing Example of External Additive 11 for Toner

An external additive 11 for toner was obtained as in the “Manufacturing example of external additive 1 for toner” except that in the above (2) of 1. Hydrolysis and condensation polymerization process, the amount of the 28% aqueous ammonia was changed to 1.0 g, the stirring temperature was changed to 40° C., and the stirring time was changed to 3.5 hours.

### Manufacturing Example of External Additive 12 for Toner

An external additive 12 for toner was obtained as in the “Manufacturing example of external additive 1 for toner” except that in the above (2) of 1. Hydrolysis and condensation polymerization process, the amount of the 28% aqueous ammonia was changed to 3.0 g and the stirring temperature was changed to 25° C.

### Manufacturing Example of External Additive 13 for Toner

An external additive 13 for toner was obtained as in the “Manufacturing example of external additive 1 for toner” except that in the above (2) of 1. Hydrolysis and condensation polymerization process, a colloidal silica aqueous dispersion B (silica solid content: 40 mass %, particle diameter: 10 nm) was used instead of the colloidal silica aqueous dispersion A, the amount of the 28% aqueous ammonia was changed to 1.0 g, the stirring temperature was changed to 45° C., and the stirring time was changed to 4.0 hours.

### Manufacturing Example of External Additive 14 for Toner

An external additive 14 for toner was obtained as in the “Manufacturing example of external additive 1 for toner” except that in the above (2) of 1. Hydrolysis and condensation polymerization process, the amount of the 28% aqueous ammonia was changed to 5.0 g, the stirring temperature was changed to 25° C., and the stirring time was changed to 2.0 hours.

### Manufacturing Example of External Additive 15 for Toner

A colloidal silica dispersion C (silica solid content: 40 mass %, particle diameter: 30 nm, 18.7 g), DI water (125 mL), and methacryloxypropyl-trimethoxysilane (16.5 g, 0.066 mol) were charged in a 250-mL four-neck round-bottomed flask equipped with an overhead stirring motor, a condenser, and a thermocouple and were heated to 65° C., and this mixture was stirred at 120 rpm. Nitrogen gas was bubbled through this mixture for 30 minutes. After 3 hours, 2,2′-azobisisobutyronitrile radical initiator (0.16 g) dissolved in ethanol (10 mL) was added thereto, and the temperature was increased to 75° C.

The radical polymerization was allowed to proceed for 5 hours, and 3 mL of 1,1,1,3,3,3-hexamethyldisilazane was then added to this mixture. The reaction was allowed to proceed for further 3 hours.

The ultimate mixture was filtered through a 170-mesh sieve to remove condensate, and the dispersion was then dried in a Pyrex (registered trademark) dish at 120° C. overnight to obtain an external additive 15 for toner.

### Manufacturing Example of External Additive 16 for Toner

An external additive 16 for toner was obtained as in the “Manufacturing example of external additive 1 for toner” except that in the above 3. Surface treatment process, no tetraethoxysilane was added.

### Manufacturing Example of External Additive 17 for Toner

An external additive 17 for toner was obtained as in the “Manufacturing example of external additive 1 for toner” except that in the above 3. Surface treatment process, the amount of tetraethoxysilane was changed to 6.0 g and the amount of dimethyldimethoxysilane was changed to 6.0 g.

### Manufacturing Example of External Additive 18 for Toner

An external additive 18 for toner was obtained as in the “Manufacturing example of external additive 1 for toner” except that in the above 3. Surface treatment process, no tetraethoxysilane nor dimethyldimethoxysilane was added, instead, hexamethyldisilazane (6.0 g) was added.

### Manufacturing Example of External Additive 19 for Toner

An external additive 19 for toner was obtained as in the “Manufacturing example of external additive 1 for toner” except that in the above (1) of 1. Hydrolysis and condensation polymerization process, the amount of dimethyldimethoxysilane was changed to 19.2 g and that in the above (2), the amount of tetraethoxysilane was changed to 8.0 g.

The physical properties of the external additives 1 to 19 for toner are shown in Table 1.

TABLE 1

| | | | | | Structural | | | Young's | |
|---|---|---|---|---|---|---|---|---|---|
| No. of | Proportion | Silanol | | | proportion of | | | modulus of | |
| external | of carbon | group | Particle | Young's | organic silicon | | | microparticle | Embedded |
| additive | atom | amount | diameter | modulus | polymer | | | B | rate |
| for toner | (%) | (mmol/g) | (μm) | (GPa) | Pa | Pb | Pc | (GPa) | (%) |
| 1 | 35 | 0.050 | 0.12 | 15 | 0.40 | 0.00 | 0.60 | 70 | 65 |
| 2 | 35 | 0.050 | 0.12 | 15 | 0.40 | 0.00 | 0.60 | 70 | 65 |
| 3 | 35 | 0.050 | 0.12 | 15 | 0.40 | 0.00 | 0.60 | 70 | 20 |
| 4 | 35 | 0.050 | 0.12 | 15 | 0.40 | 0.00 | 0.60 | 70 | 95 |
| 5 | 35 | 0.050 | 0.12 | 15 | 0.40 | 0.00 | 0.60 | 40 | 65 |
| 6 | 35 | 0.050 | 0.12 | 15 | 0.40 | 0.00 | 0.60 | 70 | 65 |
| 7 | 37 | 0.045 | 0.12 | 10 | 0.35 | 0.00 | 0.65 | 70 | 65 |
| 8 | 33 | 0.055 | 0.12 | 30 | 0.65 | 0.00 | 0.35 | 70 | 65 |
| 9 | 38 | 0.030 | 0.12 | 9 | 0.00 | 0.80 | 0.20 | 70 | 65 |
| 10 | 31 | 0.062 | 0.12 | 32 | 0.80 | 0.00 | 0.20 | 70 | 65 |
| 11 | 35 | 0.050 | 0.05 | 15 | 0.40 | 0.00 | 0.60 | 70 | 65 |
| 12 | 35 | 0.050 | 0.25 | 15 | 0.40 | 0.00 | 0.60 | 70 | 65 |
| 13 | 35 | 0.050 | 0.02 | 15 | 0.40 | 0.00 | 0.60 | 70 | 65 |
| 14 | 35 | 0.050 | 0.33 | 15 | 0.40 | 0.00 | 0.60 | 70 | 65 |
| 15 | 15 | 0.050 | 0.12 | 40 | 0.00 | 0.00 | 0.00 | 70 | 65 |
| 16 | 35 | 0.020 | 0.12 | 15 | 0.40 | 0.00 | 0.60 | 70 | 65 |
| 17 | 40 | 0.850 | 0.12 | 15 | 0.40 | 0.00 | 0.60 | 70 | 65 |
| 18 | 25 | 0.050 | 0.12 | 15 | 0.40 | 0.00 | 0.60 | 70 | 65 |
| 19 | 65 | 0.033 | 0.12 | 5 | 0.20 | 0.00 | 0.80 | 70 | 65 |

In the table, “Proportion of carbon atom” indicates the proportion of carbon concentration to the sum of carbon concentration, oxygen concentration, and silicon concentration, (dC/(dC+dO+dSi)×100), measured by ESCA, “Silanol group amount” indicates the silanol group amount per gram of an external additive, and “Particle diameter” indicates the number average particle diameter of a primary particle.

### Manufacturing Example of Polyester Resin A1

Polyoxypropylene(2.2)-2,2-bis(4-hydroxyphenyl)propane: 76.9 parts (0.167 mol);
Terephthalic acid (TPA): 25.0 parts (0.145 mol);
A dipic acid: 8.0 parts (0.054 mol); and
Titanium tetrabutoxide: 0.5 parts.

The above materials were put in a 4-L four-neck glass flask, and the flask was equipped with a thermometer, a stirrer, a capacitor, and a nitrogen induction tube and was placed in a mantle heater. Subsequently, the atmosphere in the flask was substituted with nitrogen gas, the temperature was then gradually increased with stirring, and the reaction was allowed to proceed for 4 hours while stirring at a temperature of 200° C. (first reaction process). Subsequently, trimellitic anhydride (TMA, 1.2 parts, 0.006 mol) was added thereto, followed by reaction at 180° C. for 1 hour (second reaction process) to obtain a binder resin component as polyester resin A 1. This polyester resin A1 had an acid value of 5 mg KOH/g.

### Manufacturing Example of Polyester Resin A

Polyoxypropylene(2.2)-2,2-bis(4-hydroxyphenyl)propane: 71.3 parts (0.155 mol);
Terephthalic acid: 24.1 parts (0.145 mol); and
Titanium tetrabutoxide: 0.6 parts.

The above materials were put in a 4-L four-neck glass flask, and the flask was equipped with a thermometer, a stirrer, a capacitor, and a nitrogen induction tube and was placed in a mantle heater. Subsequently, the atmosphere in the flask was substituted with nitrogen gas, the temperature was then gradually increased with stirring, and the reaction was allowed to proceed for 2 hours while stirring at a temperature of 200° C. Subsequently, trimellitic anhydride (5.8 parts, 0.030 mol %) was added thereto, followed by reaction at 180° C. for 10 hours to obtain a binder resin component as polyester resin A2. This polyester resin A2 had an acid value of 10 mg KOH/g.

### Manufacturing Example of Toner Particle 1

Polyester resin A 1:70.0 parts;
Polyester resin A 2:30.0 parts;
Fischer-Tropsch wax (peak temperature of the maximum endothermic peak: 78° C.): 5.0 parts;
C.I. Pigment Blue 15:3: 5.0 parts; and
Aluminum 3,5-di-t-butylsalicylate compound: 0.1 parts.

The raw materials shown in the above formulation were mixed using a Henschel mixer (FM-75 model, manufactured by Nippon Coke & Engineering Co., Ltd.) at a rotation speed of 20 s⁻¹ for a rotation time of 5 minutes and were then kneaded with a biaxial kneader (PCM-30 model, manufactured by Ikegai Corp.) set to a temperature of 125° C. and a rotation speed of 300 rpm. The obtained kneaded product was cooled and was roughly pulverized with a hammer mill to a diameter of 1 mm or less to obtain a coarse product. The obtained coarse product was finely pulverized with a mechanical pulverizer (T-250, manufactured by Freund-Turbo Corporation). Furthermore, classification was performed using a rotary classifier (200T SP, manufactured by Hosokawa Micron Corporation) to obtain a toner particle 1. The rotary classifier (200TSP, manufactured by Hosokawa Micron Corporation) was operated at a classification rotor rotation speed of 50.0 s⁻¹. The obtained toner particle 1 had a weight-average particle diameter (D4) of 5.9 μm.

### Manufacturing Example of Toner 1

Toner particle 1:100 parts; and
External additive 1 for toner: 6.0 parts.

The above materials were mixed using a Henschel mixer FM-10C model (manufactured by Mitsui Miike Machinery Co., Ltd.) at a rotation speed of 30 s⁻¹ for a rotation time of 10 minutes to obtain a toner 1.

### Manufacturing Example of Toners 2 to 23

Toners 2 to 23 were obtained as in the “Manufacturing example of toner 1” except that the external additive for toner and the addition amount were changed as those shown in Table 2. Physical properties of the toners 2 to 23 are shown in Table 2.

TABLE 2

External additive for toner

| | Toner particle | | Addition |
|---|---|---|---|
| Toner No. | No. | No. | amount (parts) |
| Toner 1 | Toner particle 1 | 1 | 6.0 |
| Toner 2 | Toner particle 1 | 1 | 0.2 |
| Toner 3 | Toner particle 1 | 1 | 18.0 |
| Toner 4 | Toner particle 1 | 1 | 21.0 |
| Toner 5 | Toner particle 1 | 1 | 0.05 |
| Toner 6 | Toner particle 1 | 2 | 6.0 |
| Toner 7 | Toner particle 1 | 3 | 6.0 |
| Toner 8 | Toner particle 1 | 4 | 6.0 |
| Toner 9 | Toner particle 1 | 5 | 6.0 |
| Toner 10 | Toner particle 1 | 6 | 6.0 |
| Toner 11 | Toner particle 1 | 7 | 6.0 |
| Toner 12 | Toner particle 1 | 8 | 6.0 |
| Toner 13 | Toner particle 1 | 9 | 6.0 |
| Toner 14 | Toner particle 1 | 10 | 6.0 |
| Toner 15 | Toner particle 1 | 11 | 6.0 |
| Toner 16 | Toner particle 1 | 12 | 6.0 |
| Toner 17 | Toner particle 1 | 13 | 6.0 |
| Toner 18 | Toner particle 1 | 14 | 6.0 |
| Toner 19 | Toner particle 1 | 15 | 6.0 |
| Toner 20 | Toner particle 1 | 16 | 6.0 |
| Toner 21 | Toner particle 1 | 17 | 6.0 |
| Toner 22 | Toner particle 1 | 18 | 6.0 |
| Toner 23 | Toner particle 1 | 19 | 6.0 |

### Manufacturing Example of Carrier 1

Magnetite 1 having a number average particle diameter of 0.30 μm, (magnetization strength of 65 A m²/kg in a magnetic field of 1,000/4π (kA/m)); and
Magnetite 2 having a number average particle diameter of 0.50 μm, (magnetization strength of 65 A m²/kg in a magnetic field of 1,000/4π (kA/m)).

Silane compound (3-(2-aminoethylaminopropyl) trimethoxysilane) was added to each of the above materials in an amount of 4.0 parts, followed by high speed mixing at 100° C. or more in a container to treat the respective particles.
Phenol: 10 mass %;
Formaldehyde solution: 6 mass % (formaldehyde: 40 mass %, methanol: 10 mass %, and water: 50 mass %);
Magnetite 1 treated with the above silane compound: 58 mass %; and
Magnetite 2 treated with the above silane compound: 26 mass %.

The above materials, a 28 mass % aqueous ammonia solution (5 parts), and water (20 parts) were put in a flask and were heated to and maintained at 85° C. over 30 minutes while stirring and mixing and were allowed to polymerize for 3 hours, and the generated phenolic resin was allowed to cure. Subsequently, the cured phenolic resin was cooled to 30° C., water was further added thereto, the supernatant was removed, and the precipitate was washed with water and then air-dried. Subsequently, the air-dried precipitate was dried at a temperature of 60° C. under reduced pressure (5 mmHg or less) to obtain a magnetic material dispersed spherical carrier 1. The volume-based 50% particle diameter (D50) was 34.2 μm.

### Manufacturing Example of Two-Component System Developing Agent 1

The toner 1 (8.0 parts) was added to the carrier 1 (92.0 parts) and mixed with a V-shape mixier (V-20, manufactured by Seishin Enterprise Co., ltd.) to obtain a two-component system developing agent 1.

### Manufacturing Example of Two-Component System Developing Agents 2 to 23

Two-component system developing agents 2 to 23 were obtained as in the “Manufacturing example of two-component system developing agent 1” except that the toner 1 was changed to toners 2 to 23, respectively.

### Example 1

### Method for Evaluating Toner

As an image-forming apparatus, full-color copier imagePress C800 manufactured by CANON KABUSHIKI KAISHA was used. The two-component system developing agent 1 was placed in a cyan-developing unit of the image-forming apparatus, and the above toner was put in a cyan toner container and was subjected to evaluation described below.

The modification was that the mechanism for discharging the excess magnetic carrier in the developing unit from the developing unit was removed. The amount of toner laid on paper in the FFh image (solid image) was adjusted to 0.45 mg/cm². FFh is a value of the 256 gradations expressed as a hexadecimal number, and 00 h is the first gradation (white background) of the 256 gradations, and FF is the 256th gradation (solid portion) of the 256 gradations.

### (1) Measurement of Image Density Change

As the evaluation paper, plain paper GF-C081 (A4, basis weight 81.4 g/m², available from Canon Marketing Japan Inc.) was used.

An image output test of 20,000 sheets was performed at an image percentage of 80%. During the continuous sheet passing of 20,000 sheets, the paper was passed under the same developing conditions and transfer conditions (without calibration) as those for the first sheet.

The above test was performed under a high-temperature and high-humidity environment (temperature: 30° C., relative humidity: 80%). The density of image of the initial stage (first sheet) and the density of image of the 20,000th sheet in printing at an image percentage of 80% were measured using X-Rite color reflection densitometer (500 series: manufactured by X-Rite, Incorporated), and the difference Δ therebetween was ranked by the following criteria. A rank of D or higher was judged to be good.

### Evaluation Criteria: Image Density Difference

A: Δ is less than 0.02;
B: Δ is 0.02 or more and less than 0.05;
C: Δ is 0.05 or more and less than 0.10;
D: Δ is 0.10 or more and less than 0.15; and
E: Δ is 0.15 or more.

### (2) Method for Evaluating Transferability After Durability Test

A fter output of an image on 100,000 sheets at an image percentage of 1% under a high-temperature and high-humidity environment (temperature; 30° C., relative humidity: 80%), a solid image was output. The transfer toner remained on the photosensitive member (photosensitive drum) during the solid image-forming period was torn off by sticking transparent polyester adhesive tape thereto and peeling the tape.

The peeled adhesive tape was sticked on paper, and the density thereof was measured with a spectrodensitometer (500 series, X-Rite, Incorporated). In addition, the adhesive tape alone was sticked on paper, and the density thereof was also measured.

The density difference Δ was calculated by subtracting the latter density value from the former density value and was evaluated based on the evaluation criteria shown below.

During the continuous image output of 100,000 sheets, the image was output under the same developing conditions and transfer conditions (without calibration) as those for the first sheet. In an image output durability test of 100,000 sheets, as the transfer material for evaluation, copy plain paper CS-680 (A 4 paper, basis weight: 68 g/m², available from Canon Marketing Japan Inc.) was used. The solid image after the output test was formed on a copy sheet Multi-Purpose Paper: commonly known as voice sheet (A 4 paper, basis weight: 75 g/m², available from Canon U.S.A., Inc.).

The evaluation is as follows. A rank of D or higher was judged to be good. The evaluation results are shown in Table 3.
Evaluation criteria: temperature difference
A: Δ is less than 0.02;
B: Δ is 0.02 or more and less than 0.05;
C: Δ is 0.05 or more and less than 0.10;
D: Δ is 0.10 or more and less than 0.15; and
E: Δ is 0.15 or more.

### Examples 2 to 18

Evaluation was performed as in Example 1 using the two-component system developing agents 2 to 18. The evaluation results of Examples 2 to 18 are shown in Table 3.

### Comparative Examples 1 to 5

Evaluation was performed as in Example 1 using the two-component system developing agents 19 to 23. The evaluation results of Comparative Examples 1 to 5 are shown in Table 3.

TABLE 3

| | | Image density | | Transferability after | |
|---|---|---|---|---|---|
| | | change | | durability test | |
| | Two-component system developing agent | Numerical | | Numerical | |
| | No. | value | Rank | value | Rank |
| Example 1 | Two-component system developing agent 1 | 0.01 | A | 0.00 | A |
| Example 2 | Two-component system developing agent 2 | 0.01 | A | 0.02 | B |
| Example 3 | Two-component system developing agent 3 | 0.03 | B | 0.00 | A |
| Example 4 | Two-component system developing agent 4 | 0.02 | B | 0.02 | B |
| Example 5 | Two-component system developing agent 5 | 0.02 | B | 0.04 | B |
| Example 6 | Two-component system developing agent 6 | 0.01 | A | 0.04 | B |
| Example 7 | Two-component system developing agent 7 | 0.03 | B | 0.03 | B |
| Example 8 | Two-component system developing agent 8 | 0.02 | B | 0.02 | B |
| Example 9 | Two-component system developing agent 9 | 0.02 | B | 0.05 | C |
| Example 10 | Two-component system developing agent 10 | 0.04 | B | 0.07 | C |
| Example 11 | Two-component system developing agent 11 | 0.01 | A | 0.04 | B |
| Example 12 | Two-component system developing agent 12 | 0.03 | B | 0.03 | B |
| Example 13 | Two-component system developing agent 13 | 0.02 | B | 0.04 | B |
| Example 14 | Two-component system developing agent 14 | 0.05 | C | 0.06 | C |
| Example 15 | Two-component system developing agent 15 | 0.03 | B | 0.03 | B |
| Example 16 | Two-component system developing agent 16 | 0.06 | C | 0.04 | B |
| Example 17 | Two-component system developing agent 17 | 0.11 | D | 0.08 | C |
| Example 18 | Two-component system developing agent 18 | 0.07 | C | 0.13 | D |
| Comparative | Two-component system developing agent 19 | 0.12 | D | 0.15 | E |
| Example 1 | | | | | |
| Comparative | Two-component system developing agent 20 | 0.13 | D | 0.15 | E |
| Example 2 | | | | | |
| Comparative | Two-component system developing agent 21 | 0.16 | E | 0.16 | E |
| Example 3 | | | | | |
| Comparative | Two-component system developing agent 22 | 0.18 | E | 0.14 | D |
| Example 4 | | | | | |
| Comparative | Two-component system developing agent 23 | 0.19 | E | 0.13 | D |
| Example 5 | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071466, filed Apr. 25, 2024 and No. 2025-056168, filed Mar. 28, 2025, which are hereby incorporated by reference herein in their entirety.

What is claimed is:

1. An external additive for toner, comprising:
an organosilicon polymer having a siloxane bond; wherein
in X-ray photoelectron spectroscopic measurement of the external additive, when an atomic concentration of silicon atoms is dSi, an atomic concentration of oxygen atoms is dO, an atomic concentration of carbon atoms is dC, and a sum thereof is 100 atom %, a proportion of the atomic concentration of carbon atoms bonding to silicon atoms is 30 atom % or more and 60 atom % or less,
a silanol group amount in the external additive measured by titration using KOH is 0.025 mmol/g or more and 0.800 mmol/g or less, and
for silicon atoms contained in the organosilicon polymer, when the number of all silicon atoms is 1.00, a proportion of silicon atoms indicated by Si^{a} in a structure represented by a unit (a) is Pa, a proportion of silicon atoms indicated by Si^{b} in a structure represented by a unit (b) is Pb, and a proportion of silicon atoms indicated by Si^{c} in a structure represented by a unit (c) is Pc,
Pa, Pb, and Pc satisfy following expressions (1) and (2): 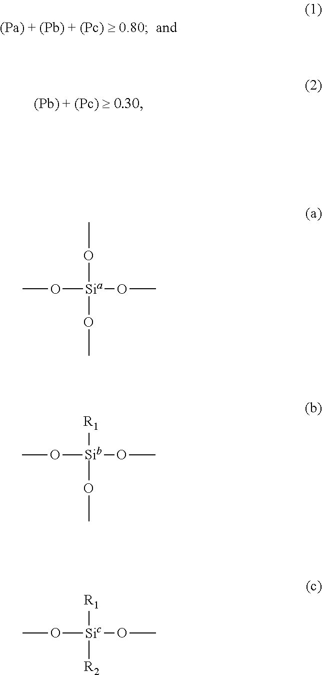
where R₁ and R₂ each independently represent an alkyl group having 1 or more and 6 or less carbon atoms.

2. The external additive according to claim 1, having a number average particle diameter of a primary particle of 0.03 μm or more and 0.30 μm or less.

3. The external additive according to claim 1, having a Young's modulus of 10 GPa or more or 30 GPa or less.

4. The external additive according to claim 1, being a composite particle including a microparticle A and a microparticle B, wherein the microparticle A is a particle including the organosilicon polymer, and the microparticle B is a microparticle that exists in a state of being at least partially embedded in the surface of the microparticle A.

5. The external additive according to claim 4, wherein the microparticle B is an inorganic microparticle having a Young's modulus of 50 GPa or more and 200 GPa or less.

6. The external additive according to claim 4, wherein an average of the embedded rate of the microparticle B represented by a following expression is 30% or more and 90% or less:
$$Embedded rate ( \% ) of microparticle B = [ ( depth of microparticle B embedded in microparticle A ) / ( diameter of microparticle B ) ] \times 100.$$

7. The external additive according to claim 1, wherein
in X-ray photoelectron spectroscopic measurement of the external additive washed with a washing method,
when an atomic concentration of silicon atoms is dSi, an atomic concentration of oxygen atoms is dO, an atomic concentration of carbon atoms is dC, and a sum thereof is 100 atom %, a proportion of the atomic concentration of carbon atoms bonding to silicon atoms is 30 atom % or more, and
a silanol group amount in the external additive measured by titration using KOH is 0.025 mmol/g or more and 0.800 mmol/g or less,
the washing method includes:
a) 10 g of the external additive is dispersed in 200 ml of hexane, followed by ultrasonication at a frequency of 30 kHz, an output capacity of 15 W, and an intensity of 100% for 5 minutes; and
b) hexane is distilled off from the dispersion of the external additive.

8. A toner comprising:
a toner particle; and
an external additive, wherein
the external additive includes an organosilicon polymer having a siloxane bond,
in X-ray photoelectron spectroscopic measurement of the external additive, when an atomic concentration of silicon atoms is dSi, an atomic concentration of oxygen atoms is dO, an atomic concentration of carbon atoms is dC, and a sum thereof is 100 atom %, a proportion of the atomic concentration of carbon atoms bonding to silicon atoms is 30 atom % or more and 60 atom % or less,
a silanol group amount in the external additive measured by titration using KOH is 0.025 mmol/g or more and 0.800 mmol/g or less, and
for silicon atoms contained in the organosilicon polymer, when the number of all silicon atoms is 1.00, a proportion of silicon atoms indicated by Si^{a} in a structure represented by a unit (a) is Pa, a proportion of silicon atoms indicated by Si^{b} in a structure represented by a unit (b) is Pb, and a proportion of silicon atoms indicated by Si^{c} in a structure represented by a unit (c) is Pc,
Pa, Pb, and Pc satisfy expressions (1) and (2): 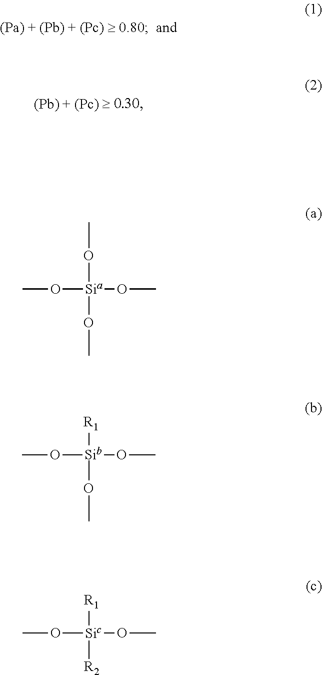
where R₁ and R₂ each independently represent an alkyl group having 1 or more and 6 or less carbon atoms.

9. The toner according to claim 8, wherein a content of the external additive is 0.1 parts by mass or more and 20.0 parts by mass or less based on 100 parts by mass of the toner particle.
